(19) United States
(12) Patent Application Publication
(10) Pub. No.: US 2003/0033369 A1
(43) Pub. Date: Feb. 13, 2003

(54) Web services container

(76) Inventor: Benjamin Karb Donovan Bernhard, Arlington, MA (US)

Correspondence Address: PENNIE AND EDMONDS, 1155 AVENUE OF THE AMERICAS, NEW YORK, NY, 100362711

(21) Appl. No.: 10/215,722

(22) Filed: Aug. 9, 2002

Related U.S. Application Data
(60) Provisional application No. 60/311,126, filed on Aug. 9, 2001.

(51) Int. Cl. G06F 15/16

(52) U.S. Cl. 709/203

(57) ABSTRACT

An electronic server system for providing services to client programs is disclosed. In a preferred embodiment, the present electronic server system comprises a first container application and a second container application implemented as at least one first component deployable into the first container application. The second container application is further configured to support deployment of at least one second component into the second container application and the at least one second component is configured to utilize Web services messaging.

### FIELD OF THE INVENTION

The field of this invention pertains to container programs for deploying applications, and in particular to a server system supporting dynamic deployment and upgrade of Web service software packages.

### BACKGROUND OF THE INVENTION

Web services are typically provided using the Simple Object Access Protocol (SOAP) and Web Services Definition Language (WSDL). Web Service messages are commonly communicated over HyperText Transfer Protocol (HTTP), but can also use other protocols such as TCP, SMTP and even FTP. When used in combination, these technologies allow systems to communicate over both public and private networks. Since the communication protocol and transport are standard, the systems that are communicating have no other compatibility requirements. For example, the system making a request may be implemented using Microsoft's .NET platform while the system receiving and executing the request may be hosted on IONA's iPortal Application Server. The functionality provided using these mechanisms is called a Web Service. More specifically, “web service” as used herein means a service that: a) sends or receives XML data; b) sends or receives data defined in an XML Schema; or c) sends or receives data using SOAP, HTTP, HTTPS, JAXM, RMI, FTP, XML-RPC or SMTP.

Conventional Web services systems generally require that Web services be installed using one of two possible strategies. Independent vendors are utilizing a two-step installation process that allows them to implement and market Web service functionality add-ons to third party application server platforms. Application server platform vendors are creating aggregate products that embed Web service functionality into their core platform. Both strategies have significant shortcomings.

Systems that use a two-step installation process typically provide a set of libraries and tools that implement Web services functionality. These components are installed using a process that is independent of the application server installation process. Developers then use these tools to tie Web service requests to invocations on implementation code. This can be accomplished by developing code manually, generating code automatically, or using GUI tools that specify the bindings, depending on the tool's implementation architecture.

When the bindings between Web service messages and the implementation code are defined and implemented, the developer proceeds to step two and deploys to a host application server. The developer must bundle together both the infrastructure that implements Web service message handling and a Web service that uses the infrastructure. This bundle can take many forms, and the only requirement is that both the Web service infrastructure and Web service instances are somehow correlated and combined in a way that the host system understands. Examples include directory structure standards, and compressed file archives like the Web Application Archive (WAR) and Enterprise Application Archive (EAR) defined by J2EE. These bundling formats may be industry standard or proprietary to a particular host server. Currently, the process of creating the bundle varies with different application server implementations. Once a bundle is created, the user copies the archive into the application server environment and registers it with the application server. These steps are accomplished using tools provided by the application server. These tools also vary from vendor to vendor.

If the Web service processing infrastructure is improved, upgrades follow a similar two-step procedure. First, the user must install the improved libraries and tools. Second the user must re-bundle their Web service to implementation bindings and redeploy the application server. It may also be necessary to re-write or re-specify how Web service requests are mapped to the operation's implementation.

This conventional approach has obvious limitations:

The two step process is inconvenient for developers.

Upgrades are especially onerous since each uniquely deployed Web service must be individually updated with the new infrastructure. It will be difficult for a deployed site to update a set of Web services concurrently. During the upgrade, the system will be in an inconsistent state unless extraordinary measures are taken.

For Web services infrastructures that support multiple application server platforms, the second step is unique on every platform. This dictates unique documentation. Further, the Web service tool's user community is fragmented by the unique considerations of their different host platforms.

Unlike the foregoing systems which require two-step installation, aggregate products embed Web service functionality into their application server implementation. Since the functionality is deployed with the application server, there is no separate installation or deployment step required for the Web services infrastructure. Vendors provide tools that allow users to construct and deploy Web services directly into the host. This approach offers a substantial usability improvement over the two-step approach discussed above. However, there are critical shortcomings:

The Web services infrastructure is tightly coupled with the application server platform. Current implementations do not allow users to install or upgrade Web services support independently. The entire server must be upgraded- usually with significant impact on existing applications. It is further not currently possible to upgrade the Web services support while the application server is running and servicing Web service requests.

The Web service infrastructure only supports the vendor's application server. The same infrastructure cannot be used across multiple application servers.

### SUMMARY OF THE INVENTION

One aspect of the presentation invention comprises an electronic server system for providing services to client programs comprising a first container application and a second container application implemented as at least one first component deployable into the first container application. The second container application is further configured to support deployment of at least one second component into the second container application and the at least one second component is configured to utilize Web services Messaging.

Another aspect of the present invention comprises an electronic server system wherein the second container application is configured to provide at least one interface supporting Web services Messaging.

Yet another aspect of the present invention comprises an electronic server system wherein the second container application supports Web services Messaging over at least two different transport protocols.

Yet another aspect of the present invention comprises an electronic server system wherein the deployment of the second container application into the first container application does not require a change of any configuration affecting any other application or service provided by the host system on which the first container application is executing.

Yet another aspect of the present invention comprises an electronic server system wherein the deployment of the second container application into the first container application does not require the first container application to be restarted.

Yet another aspect of the present invention comprises an electronic server system further comprising a first container metadata for deploying the second container application into the first container application, and a third container metadata for deploying the second container application into a third container application.

### BRIEF DESCRIPTION OF THE DRAWINGS

FIG. 1 schematically depicts a structure of the Web service container.

FIG. 2 schematically depicts a structure of the Web service container containing XAR archives.

FIG. 3 schematically depicts a structure of an XAR archive.

FIG. 4 schematically depicts a structure of the Web service container containing XAR archives in a preferred embodiment.

FIG. 5 schematically depicts a structure of the Web service container.

FIG. 6 schematically depicts the process of obtaining Web service using a preferred embodiment of the present invention.

FIG. 7 schematically depicts two configurations of deployed Web services in a preferred embodiment.

FIGS. 8-14 schematically depict the screens shots for installing the preferred embodiment on IONA iPortal Server.

FIGS. 15-20 schematically depict the screens shots for installing the preferred embodiment on BEA Web Logic Server.

### DESCRIPTION OF THE PREFERRED EMBODIMENTS

The present invention comprises a container application that reduces difficulties associated with deployment and upgrades, and in one embodiment, is especially suited to the provision of rapidly evolving Web services and Web services infrastructure. An installation process provides support for multiple host platforms. An upgrade process can install an enhanced Web service infrastructure without requiring the user to re-deploy existing Web services instances. This upgrade can be performed while the system is actively processing Web service messages.

The installation of the Web services infrastructure is accomplished in one step. After installation, pre-constructed, pre-packaged Web services distributed with the infrastructure are immediately available. Users can then develop and deploy new Web services instances. The process of deploying these new instances of Web services requires only one step and does not involve any changes to the Web service infrastructure. When upgrades to the Web services infrastructure become available, they can be installed into a running system in one step.

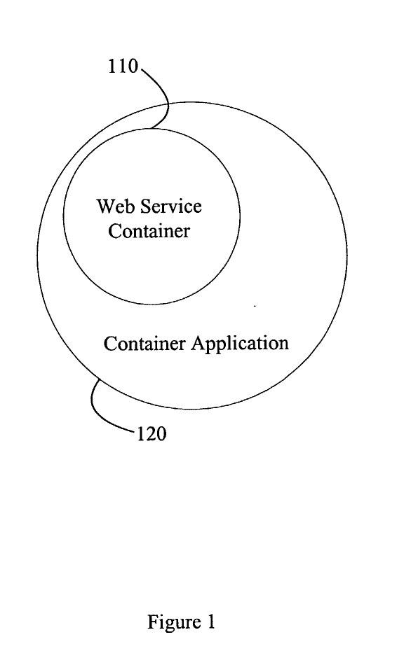

As illustrated in FIG. 1, in a preferred embodiment, the Web services infrastructure implements a container application 110 for deploying Web service instances and is deployed directly into a container application 120 such as a Servlet container or a J2EE server.

As used herein, “container” or “container application” means a computational entity or a collection of computational entities that provides services to software components, including version or bundle isolation, a bundling facility for assembling components into an application or other aggregate (such as a WAR in J2EE, or an assembly in .NET) and an installation facility for deploying a bundle. “Component” means a reusable program building block that can be combined with other components in the same or other computers in a distributed network to form an application. “Deploying into a container” means using a container's installation facility to deploy a bundle. “Version isolation” means allowing two different versions of the same component, class, module, library or other collection of executable code to be used in a single application or process. “Bundle isolation” means that no component, class, module, library or other collection of executable code deployed as a part of or used by a bundle can conflict with the use of any component, class, module, library or other collection of executable code deployed as a part of or used by any other bundle.

In a preferred embodiment, the host platform is a J2EE server. The infrastructure that provides for Web service message handling and dispatching to Web service implementation code is packaged as a WAR file. The installation process for the system automatically deploys and initializes this WAR file in the host application server. The deployment is persistent; unless specifically un-deployed or uninstalled, the Web services infrastructure becomes a permanent part of the host. If the host application server is restarted or reset, the Web services infrastructure is similarly restarted or reset.

In an alternative embodiment, the host platform is a server running Microsoft .NET. The infrastructure that provides for Web service message handling and dispatching to Web service implementation code is packaged as an assembly. The installation process for the system automatically deploys and initializes this assembly in the .NET server.

Other alternative embodiments may comprise software units implemented using any existing programming language or technologies supported by the host container application.

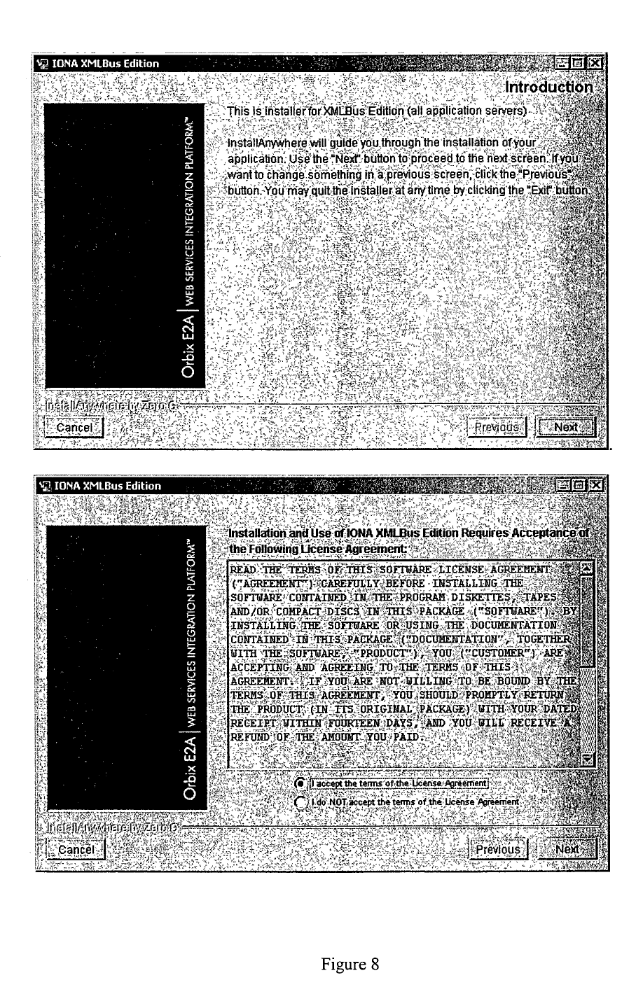

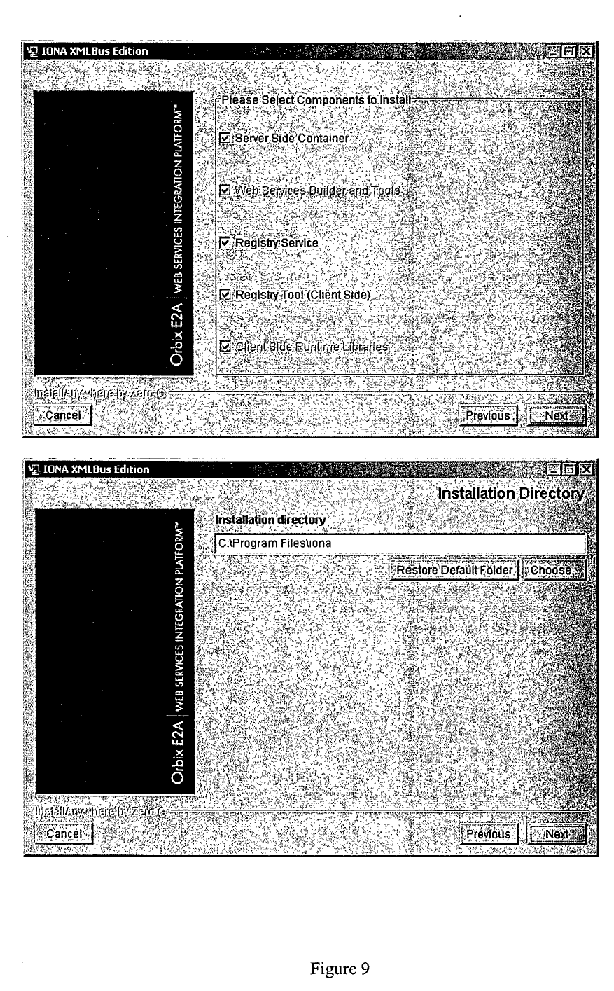

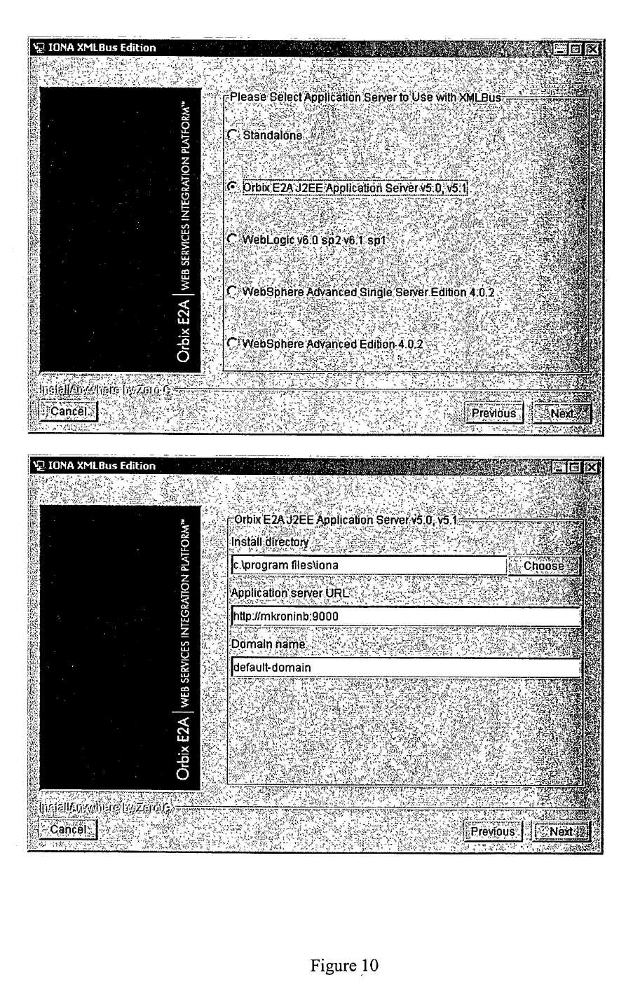

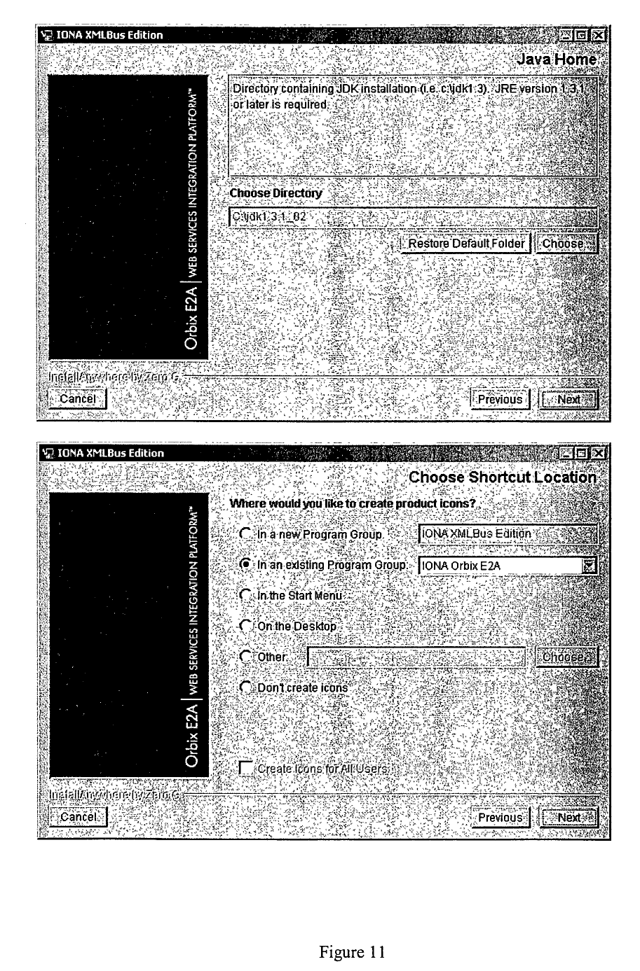

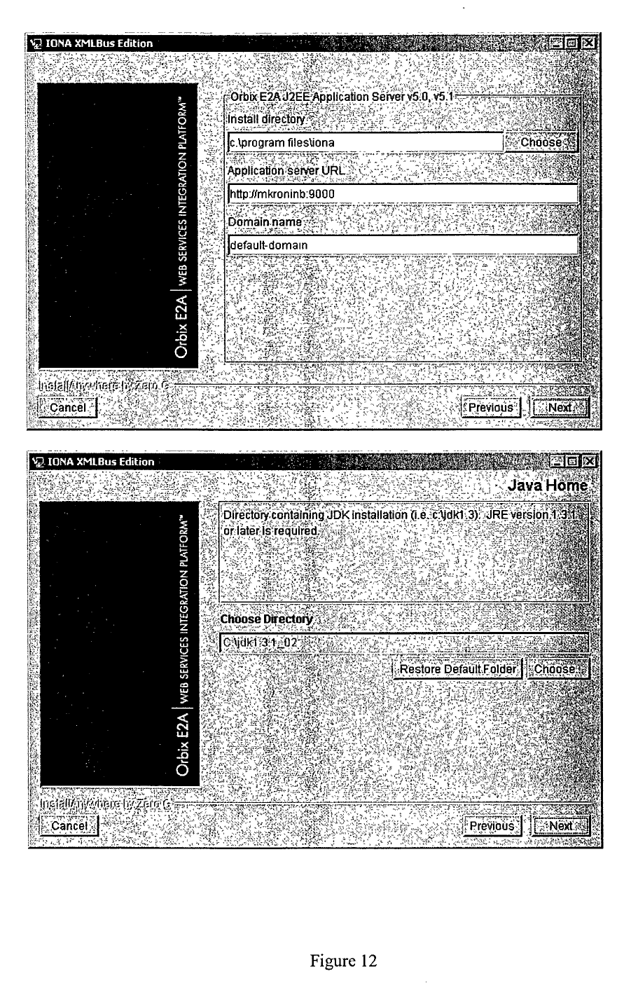

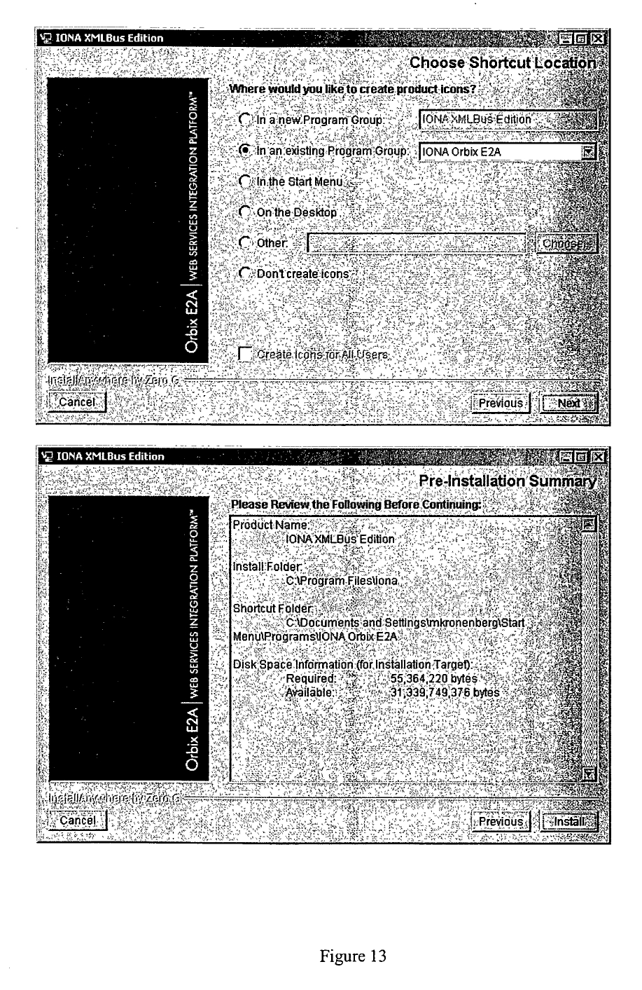

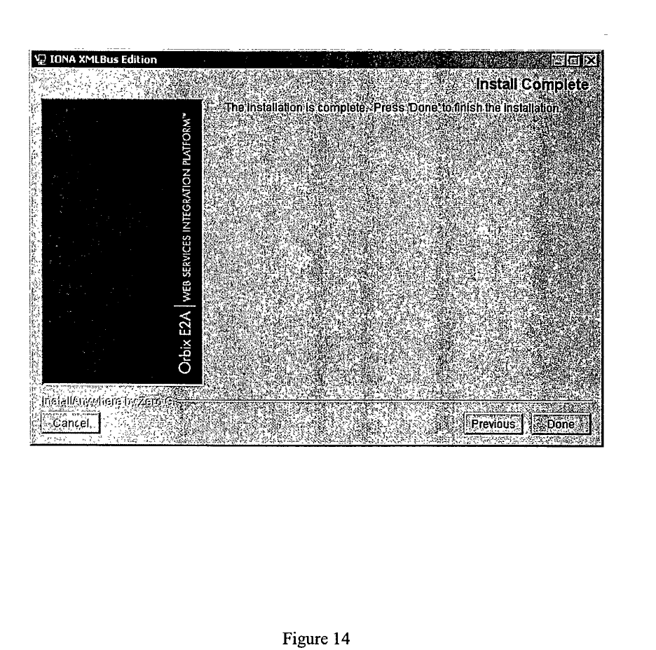

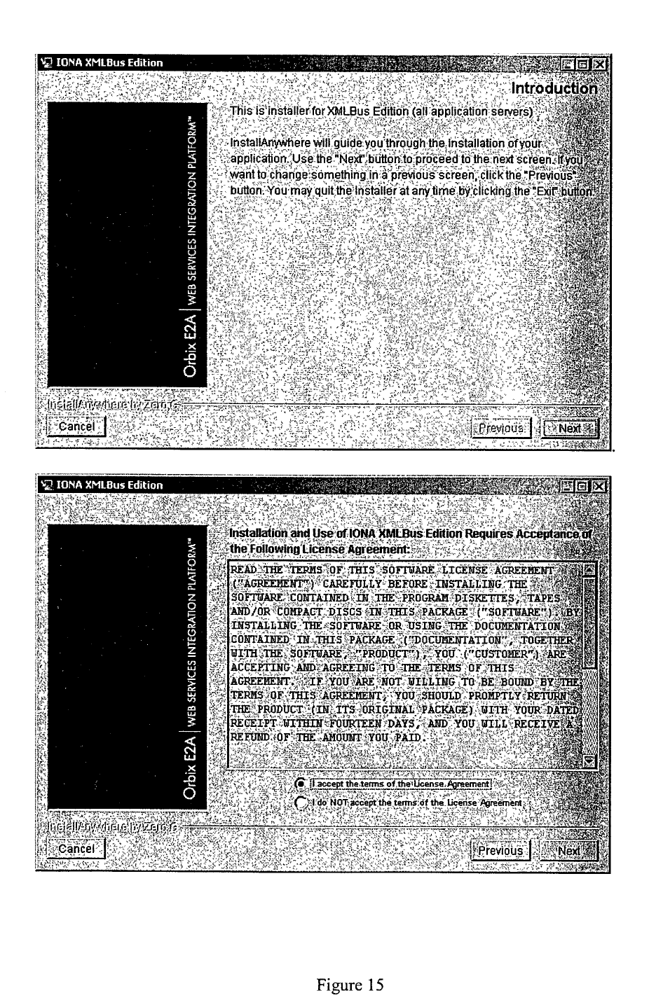

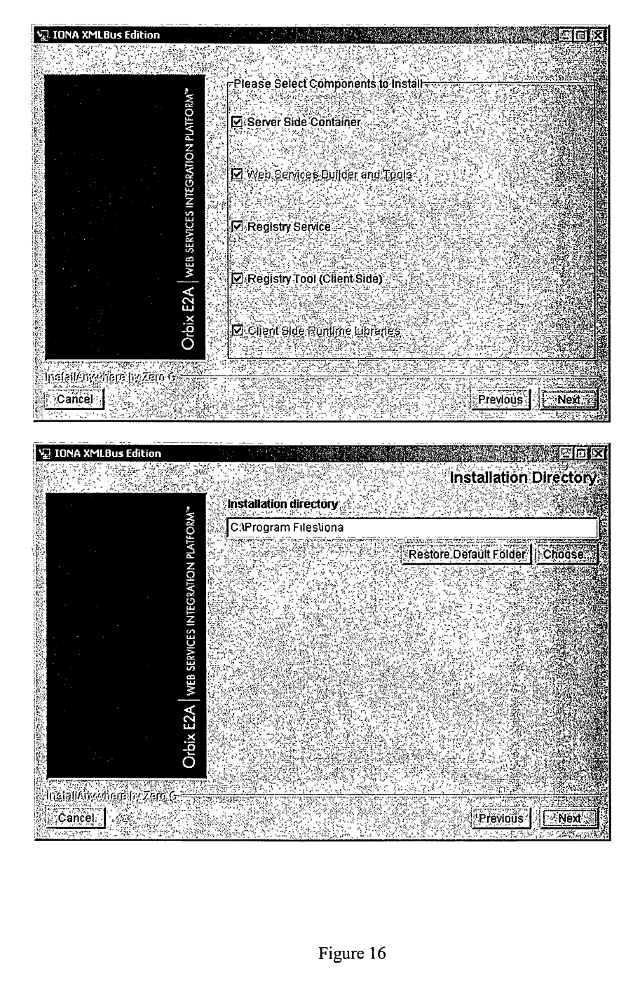

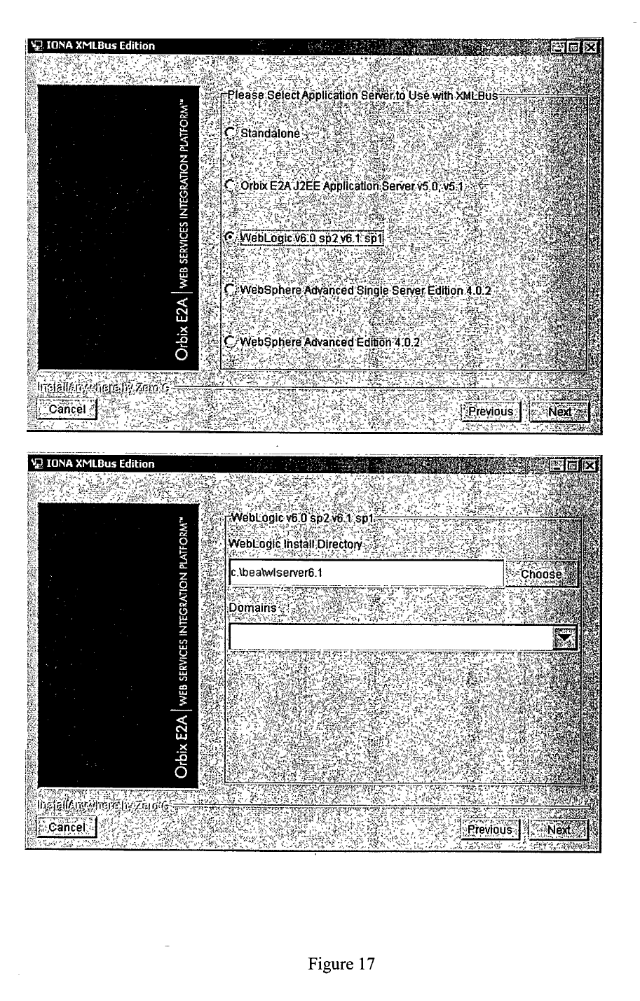

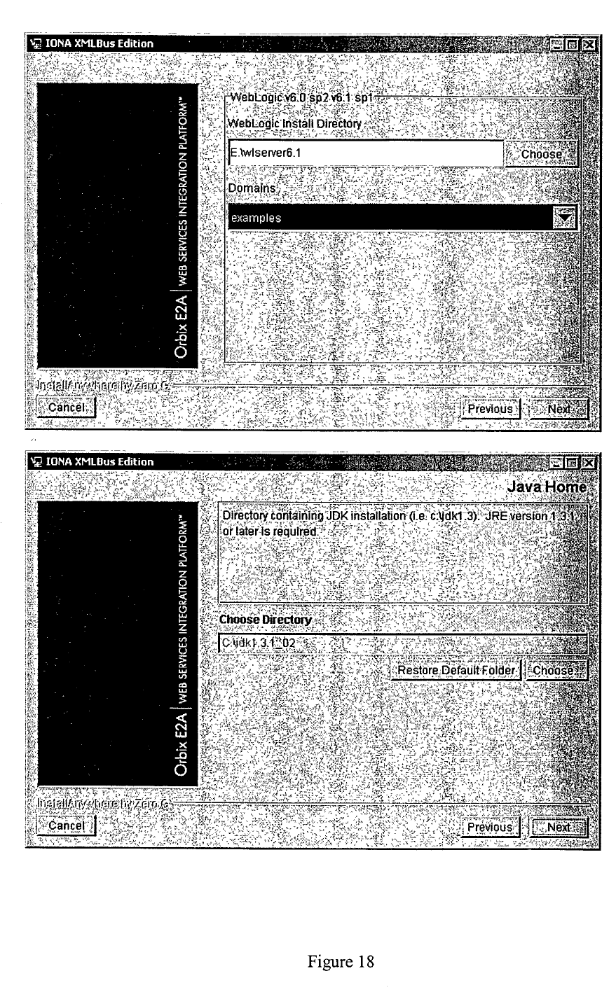

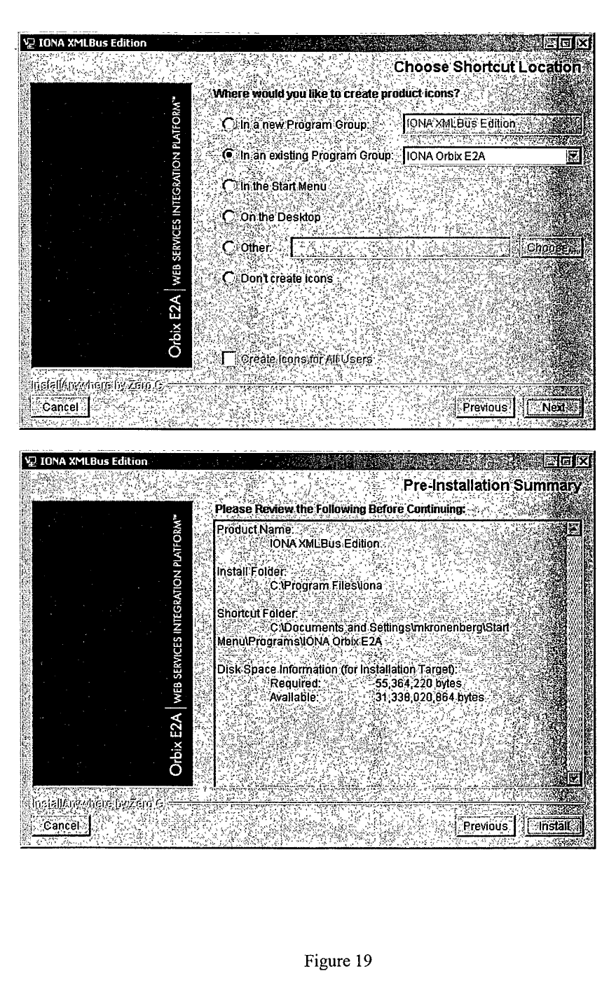

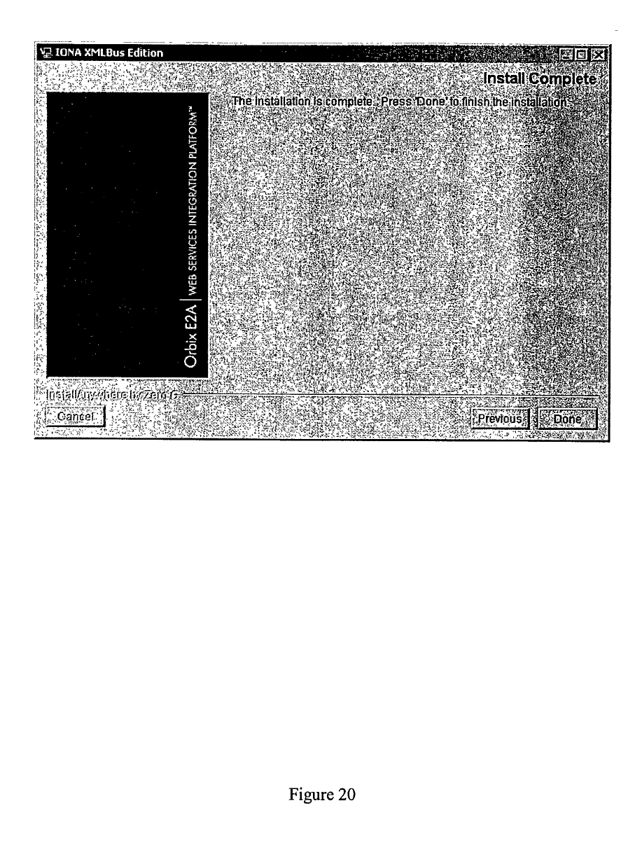

The preferred embodiment supports a variety of J2EE servers. As noted earlier, the process of deploying a WAR into an application server is vendor-specific. The preferred embodiment manages vendor-specific platform details in the installation process and hides them from the user. To accomplish this, the installation process has a distinct deployment step for each supported platform. This deployment step uses platform-specific, proprietary APIs and/or proprietary procedures to configure, deploy, and initialize the pre-packaged Web services WAR. The user is prompted for basic host information including application server installation directory and port numbers. The entire process is automated and GUI driven. Screen shots for a variety of platforms are illustrated in FIGS. 8-20.

The preferred embodiment provides a Web services Archive (XAR) bundling facility. The format of an XAR file includes all materials necessary to describe a set of Web services. The preferred embodiment provides tools for binding Web services to implementation logic, assembling Web services into XAR files, and deploying the XAR file into the infrastructure previously installed into the host application server. This deployment process is unchanged across all host platforms.

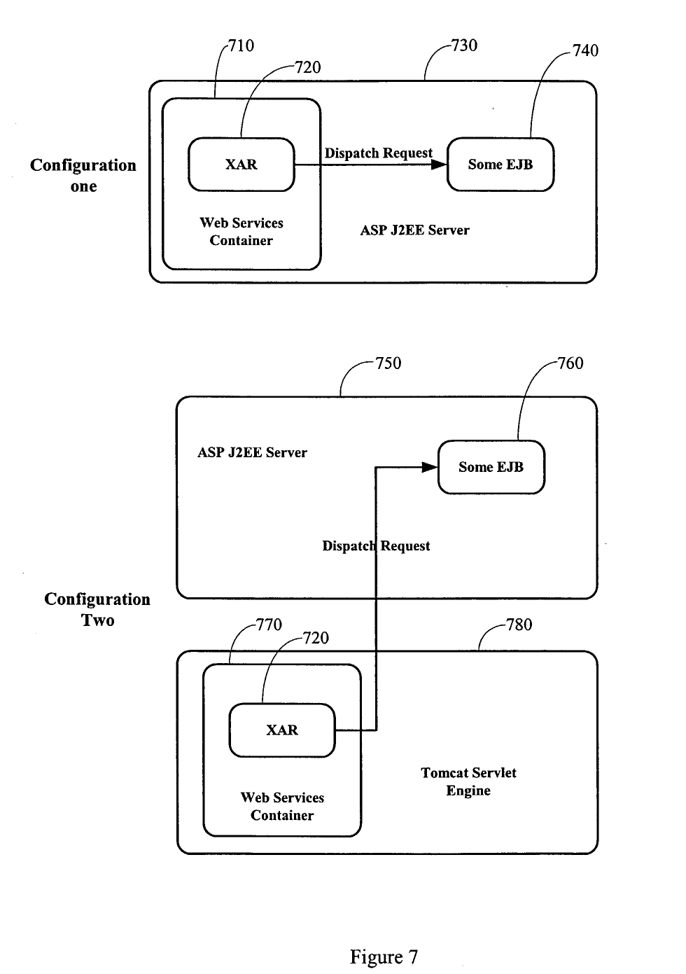

An XAR can be deployed on any platform on which a Web services container is running, without regard to the underlying J2EE platform supporting the Web services container. The XAR has no dependency on the underlying application server, and any EJBs required by the XAR may be instantiated on any J2EE server, as illustrated in FIG. 7.

Most container application servers implement a dynamic deployment feature. This feature allows a WAR or EAR to be deployed while the application server is running. If a previous version of the archive had been deployed, the new version will replace it. The application server will switch requests from the old archive to the new one. In a preferred embodiment, the present invention is designed to use this feature to deliver infrastructure upgrades. As mentioned before, the Web services infrastructure is deployed into the container application as a bundle, such as a WAR file. The XAR files supported by the Web services infrastructure are preferably compatible across all versions of the system. With this design, new versions of the system can be installed while the application server is running and processing SOAP requests. One preferred Web services infrastructure upgrade proceeds as follows:

1. An existing installation is running. The application server has loaded the Web services container application archive. The Web services container is receiving requests. Deployed XAR bundles have been loaded into memory. SOAP requests are dispatched to the in-memory Web services for processing.

2. The upgrade is begun by calling the installation facility of host platform. The WAR containing the new version of the Web services container is deployed into the application server. The application server loads the new Web services container application archive. Requests are no longer sent to the original version, but are now sent to the newly deployed Web services container. The new version of the Web services container loads the XAR files that were deployed into the original container.

This dynamic upgrade feature allows the run-time installation of an improved Web services infrastructure. The improvements available are generally of two categories: (i) improvements immediately available to Web services constructed and deployed with earlier versions, such as improved SOAP and WSDL standard compliance, improved performance, improved scalability, improved management; (ii) improvements that can only be used by new Web services specifically constructed to use the enhancements, such as support for new data types, support for new transport options, and support for new APIs.

Bundles deployed into the Web services container preferably comprise self-describing metadata for Web services they implement. The use of metadata avoids version conflicts between Web services using different versions of a software implementation. It further eliminates “bundle conflicts” between Web service bundles using inconsistent software configurations. The introduction of metadata allows a Web service bundle to be deployed into and updated within the host system without affecting other services' (including Web services') configurations and without restarting the server system. It enables the Web services container to consistently isolate Web service application implementation logic from the Web services infrastructure and the host platform. Because of this isolation, the environment provided to support Web services functionality is consistent across platforms and transports.

The metadata preferably includes information about properties, configurations, and optionally code implementations of one or more Web services. Properties of a Web service preferably include information about how the Web service was is used. For example, properties preferably include the URL for the Web service endpoint, and the classes and methods the Web service supports. The configuration of a Web service preferably includes information about where Web service implementations are located. For example, it describes where JARs or assemblies are located. The configuration file can be realized as manifest for JARs or assemblies and Java or C# classes can be located and loaded into the server system using Java class loader or C# AssemblyResolver. Details of Java class loader and C# AssemblyResolver can be found at http://java.sun.com/j2se/1.4.1/docs/api/java/lang/ClassLoader.html and “Programming in C#” by O'Reilly, respectively. These documents are hereby incorporated herein by reference.

Metadata is preferably automatically created whenever a Web service bundle is built. Metadata is preferably associated only with the Web service bundle from which it is created and this metadata is used by the preferred Web service container to interpret and demarshal the incoming request and tie the request to the correct server application code implementation described in the metadata. Whenever a new Web service bundle is loaded into the server system, it is automatically deployed by the Web service container according to its metadata. Whenever an update occurs, the Web service container reads the updated metadata and ties the request message to the updated service implementation.

A preferred embodiment of the present invention comprises a J2EE implementation of the Web service container. This embodiment may execute either on a J2EE application server or stand alone. [[CLAIM DUAL FUNCTION]] The Web service container further supports a plurality of running Web services described by corresponding metadata. If the Web service implementation consists of local Java class files, these files and any class dependencies are included in the Web service. The metadata may also include SOAP configuration files incorporating the reference information of EJBs. The Java or EJB implementations of a Web service can also access any backend applications they need in their usual way.

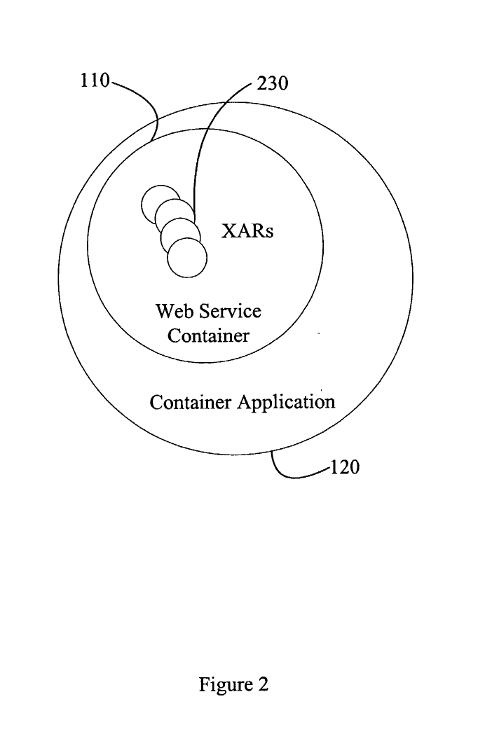

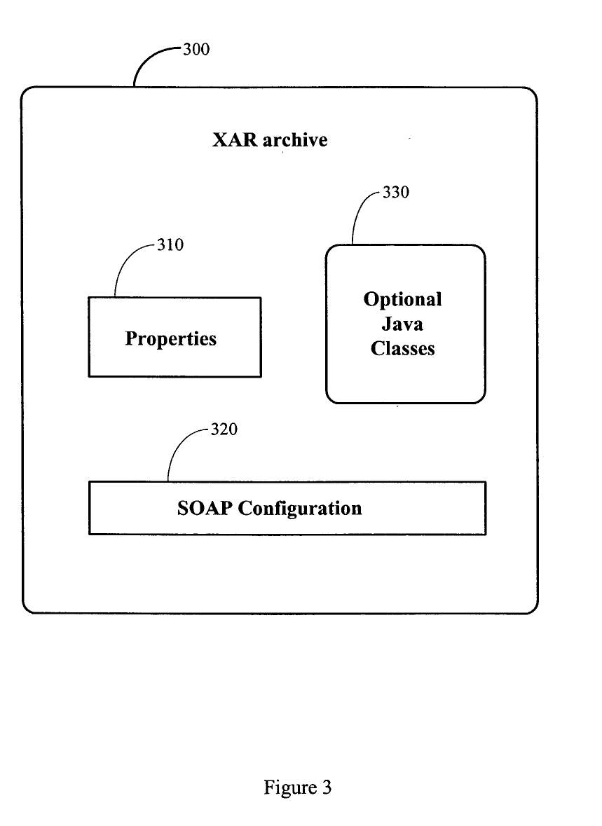

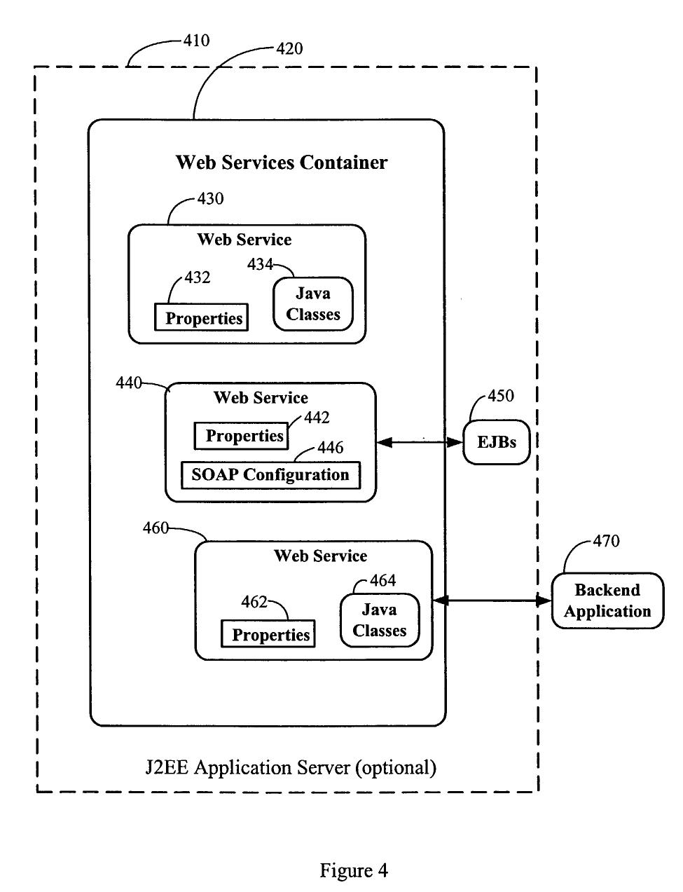

In the preferred embodiment, Web service bundles are implemented as XAR archive files 230 as shown in FIG. 2. As depicted in FIG. 3, the metadata of an XAR comprises a property file 310, a configuration file (preferably comprising SOAP configuration information) 320 and optionally some Java classes 330 providing additional implementation of Web services. FIG. 4 depicts a structure of the Web service container containing XAR archives 410, 420, 430. The XAR metadata contains all materials that the Web services Container needs to launch and run the new Web service. After the Web service is encapsulated as an XAR, it can be deployed directly into a running Web services container. The Web service container then updates immediately and re-loads any changed classes. In addition, if the Web services Container restarts, it automatically redeploys all the Web services. When the Web service is sent its first SOAP message, the Web service container generates WSDL that describes the Web service it reads from the property file in the XAR.

In another preferred embodiment, the system further comprises a Web service builder for creating a Web service from a working application such as a Java or C# component. This tool generates an XAR metadata file. As described above, the XAR metadata file includes information the container application uses to deploy the service. In addition, the Web service builder preferably can automatically produce a fully functioning, stand-alone test client that uses the new Web service. This generated client can be used to test the new Web service. The test client is preferably implemented with a graphical user interface and provides a generic client for testing Web services.

The system also preferably comprises an Interop test client that tests any deployed Web service for interoperability with the Round 1 Interoperability Web services, as described at http://www.xmethods.com/ilab, which is hereby incorporated herein by reference. The Interop Test Client automatically generates clients and then runs them against the Web service.

The system preferably further comprises a SOAP message test client that lets developers enter a SOAP request directly, send it to a server, and monitor the result.

The system also preferably comprises a Web service manager for Web service administrators to administer Web services deployed into the Web service Container. The Web service manager may display the deployed Web services, the WSDL information for each Web service, and the endpoints on which an implementation is running. The Web service manager also preferably provides access to service life cycles and the runtime environment as well as management interfaces to facilitate service deployment and administration.

The system also preferably comprises a business registry manager that is a graphical tool that supports browsing and editing UDDI repositories for Web services.

Preferably the system further comprises Java application programming interfaces (APIs) that are used to allow developers to customize how messages are processed on both clients and servers.

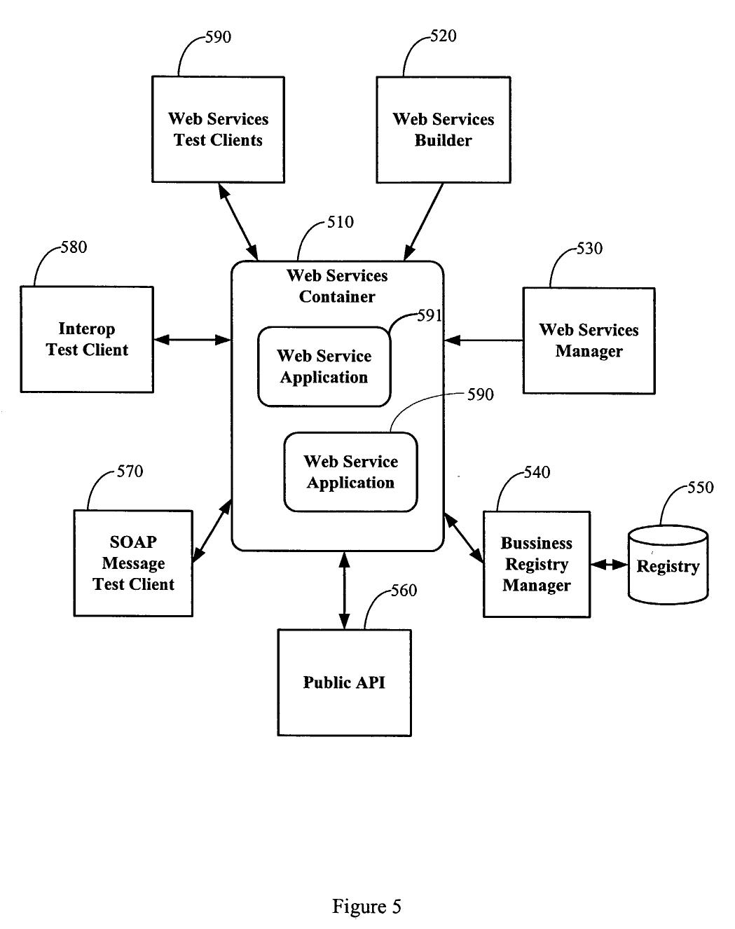

The architecture of a preferred embodiment of the system is shown in FIG. 5. This embodiment uses established Web service standards for smooth interoperability between different application server platforms. These standards include XML, HTTP, SOAP, WSDL and UDDI.

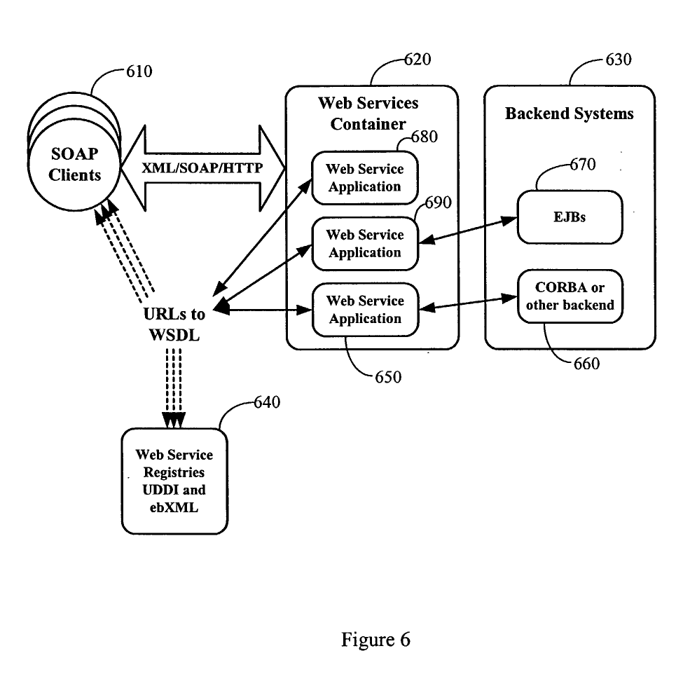

A typical process of invoking a Web service using this embodiment is depicted in FIG. 6 and is described as follows. First, the client 610 determines a URI for the Web service and how to interact with the Web service using WSDL describing the Web service. Typically, a well-known URI is used to access a document containing WSDL describing the service. The URI might be obtained from the Web service provider, using conventional methods such as E-mail, or the URI might be obtained from a UDDI repository, if the provider has registered the Web service in UDDI. The URI may also be obtained using Discovery if a .NET server is used to provide Web service.

Secondly, a client 610 invokes a method on a Web service using SOAP, and typically, HTTP. The Web services test client of the preferred embodiment permits testing of a Web service without manually programming a client. Java client stubs are also provided that automatically convert Java method invocations into Web service requests. Programmers wishing to use other languages can build clients that adhere to the standard WSDL generated by the preferred embodiment.

Next, information contained in the SOAP message directs the HTTP call to the appropriate server-side Web services Container 620. The Web services Container 620 has a SOAP listener that validates the SOAP message against the corresponding XML schemas, as defined in the WSDL that describes the Web service, and then unmarshals the SOAP message. Within the Web services Container, dispatchers invoke the corresponding Web service implementation code residing in the Backend Systems 630.

What is claimed is:

1. An electronic server system for providing services to client programs, comprising:
a first container application;
a second container application implemented as at least one first component deployable into the first container application;
the second container application being further configured to support deployment of at least one second component into the second container application.

2. The server system of claim 1, wherein the second container application being configured to provide version isolation to components deployed into the second container application.

3. The server system of claim 1, wherein the second container application being configured to so that the at least one first component implementing the second container application is version-isolated from the first container application.

4. The server system of claim 1, wherein the second container application being configured so that components deployed into the second container application are version-isolated from the second container application.

3. The system of claim 1, wherein the second container application is configured to provide at least one interface supporting a Web Service.

4. The system of claim 1, wherein the second container application supports at least two different Web Service transport protocols.

5. The system of claim 1, wherein the deployment of the second container application into the first container application does not require a change of any configuration affecting any other application or service provided by the host system on which the first container application is executing.

6. The system of claim 1, wherein the deployment of the second container application into the first container application does not require the first container application to be restarted.

7. The system of claim 1, further comprising:
first container metadata for deploying the second container application into the first container application;
third container metadata for deploying the second container application into a third container application.

8. The system of claim 1, wherein the second container application is capable of operation without being deployed into the first container application.
